(19) United States
(12) Patent Application Publication
(10) Pub. No.: US 2007/0260595 A1
(43) Pub. Date: Nov. 8, 2007

(54) FUZZY STRING MATCHING USING TREE DATA STRUCTURE

(75) Inventors: Bryan Kendall Beatty, Sammamish, WA (US); Nikolai Michael Faaland, Sammamish, WA (US); Duncan Murray Lawler, Bothell, WA (US); Elizabeth Jean Wood, Bothell, WA (US); David P. Horne, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/381,182

(22) Filed: May 2, 2006

(51) Int. Cl. G06F 17/30

(52) U.S. Cl. 707/5

(57) ABSTRACT

The subject disclosure pertains to systems and methods for performing fuzzy searches of a tree data structure. A search request can include a search term or terms and search conditions. The tree is traversed in response to the search request and nodes of the tree are examined using a function or set of rules to generate a score. The score reflects the probability that the current node is a match to the search term and can be used to determine the search results to be returned. Due to the organization of the tree, if the score indicates that the current node is not a possible match, child nodes of the current node will not be possible matches. Therefore, the traversal of the current node and its children can be terminated.

### BACKGROUND

Common computer-related problems involve managing large amounts of data or information. Information should be efficiently maintained to minimize the amount of storage required. In addition, information should be maintained such that relevant data within the data set can be quickly located and retrieved.

One methodology for storing information utilizes a tree data structure. Typically, in tree data structures information is stored as a series of nodes in a hierarchical arrangement. Relationships among data stored in the nodes are represented by the parent and child relationships that form the tree. The hierarchical nature of a tree structure facilitates efficient retrieval of data from the tree. Each node can include a unique key, such that nodes can be located and identified based upon the key. Data associated with the key can be maintained within the node or in a separate data store referenced by the node. A data store as used herein is any collection of data including, but not limited to, a database or collection of files, including text files, web pages, image files, audio data, video data, word processing files and the like. In general, searching the tree involves starting at the root node of the tree and traversing the tree while evaluating the key of the current node and a desired search term. Search algorithms move recursively through trees until a termination condition is met. Typical termination conditions include location of the desired information or exhaustive search of the tree.

In general, tree search algorithms retrieve a single child node that matches the search terms exactly. However, if the input search term is incorrect, the search algorithm may be unable to locate the desired node of the tree and therefore the relevant data. In particular, user input is likely to include errors. Users are prone to errors either in selection of search terms or in entering the terms. For example, if the search term is a text string, a user may enter a homonym of the desired word or simply mistake the spelling of a word. In addition, the search term can include a typographical error, such as transposition of letters within a word. Search terms can also include multiple words, in which case users may mistake the order of words or may not know all of the words. These sorts of common errors can make it difficult for search algorithms to locate and return relevant information to a user.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the provided subject matter concerns performing fuzzy matching during search and retrieval of data from a tree data structure. In general, during a standard tree search the tree nodes are examined and if the key of a node exactly matches the search term, the node is returned as a result of the search. During fuzzy matching, for each node examined a score is generated that indicates the probability of a match between the search term and the key of the node. If the score is below a predetermined threshold the current node is not considered a possible fuzzy match and will not be returned as a search result. The score can be calculated independently for each node, or be made to take into account previously calculated scores of parent nodes. Using the latter methodology, the hierarchical organization of the tree can be made to ensure that the score for each child node of the current node is less than that of the current node. Therefore, any child node of the current node will not be a possible fuzzy match and need not be evaluated. Consequently, only a portion of the nodes need be evaluated during a search.

Users or client applications can specify search terms and conditions to be used during the search of the tree data structure. For example, users can provide criteria to sort, order or filter the list of search results before the results are provided to the user or client application. In addition, the user or client application can specify the threshold used to determine whether a node is considered a possible match. Users or client applications can also select or update the function or set of rules used to evaluate a node and determine the score.

Some types of data or entities to be stored within the tree can be composed of subgroups, such that each subgroup can be separately stored in the tree. Similarly, the search term can be separated into subgroups, such that individual subgroups can be separately searched and the combination of individual subgroup results can be evaluated to return possible results. For example, where data to be stored in the tree includes text strings or phrases composed of multiple words, each word can be stored in a separate node within the tree. Each such node can include references that indicate the phrases of which the word can be a part. Search terms that include multiple words can be separated into words and searched individually. After search results for each word have been located, the combined search results can be evaluated. The individual words of the search term, the individual word search results and the original strings stored in the tree are evaluated to generate search results for the entire search term. By evaluating the search term as a collection of subgroups rather than a single entity, the search algorithm can allow for errors in subgroup order or composition to provide relevant, possible matches that might not otherwise have been returned.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system for performing a search of a tree data store in accordance with an aspect of the subject matter disclosed herein.

FIG. 2 is a block diagram of an exemplary trie data structure.

FIG. 3 is a block diagram of a system for performing a fuzzy matching search of a tree data structure in accordance with an aspect of the subject matter disclosed herein.

FIG. 4 is a block diagram of a system for performing a fuzzy matching search utilizing subgroups of a tree data structure in accordance with an aspect of the subject matter disclosed herein.

FIG. 5 is a block diagram of a flow chart for retrieving data from a tree data structure utilizing fuzzy matching in accordance with an aspect of the subject matter disclosed herein.

FIG. 6 is a block diagram of a flow chart for retrieving data from a tree data structure utilizing fuzzy matching in accordance with an aspect of the subject matter disclosed herein.

FIG. 7 is a block diagram of a flow chart for evaluating a node of a tree data structure utilizing fuzzy matching in accordance with an aspect of the subject matter disclosed herein.

FIG. 8 is a block diagram of a flow chart for generating a tree data structure utilizing subgroups in accordance with an aspect of the subject matter disclosed herein.

FIG. 9 is a block diagram of a flow chart for retrieving data from a tree data structure utilizing subgroups in accordance with an aspect of the subject matter disclosed herein.

FIG. 10 is a schematic block diagram illustrating a suitable operating environment.

FIG. 11 is a schematic block diagram of a sample-computing environment.

### DETAILED DESCRIPTION

The various aspects of the subject matter described herein are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. The subject matter disclosed herein is not limited by such examples. In addition, any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

In one exemplary application, a tree data structure can be used to maintain a set of text strings. For example, the names of various geographical features can be represented as keys for nodes of the tree. Each node can include one or more values including geographic information. Alternatively, the value can serve as a reference or pointer to information associated with the geographical feature stored in a separate data store. Information for specific geographic features can be retrieved by searching the tree using a search term based upon the geographic feature name. During searches, the tree data structure can be traversed and node keys can be compared to the search term. When a node key matching the search term or geographic name is located, a node value included in the node can be used to retrieve information from a data store.

To increase robustness of searches, fuzzy matching can be used to evaluate the nodes of the tree data structure and locate imperfect, possible matches for the search term as well as exact matches. During fuzzy matching items that are similar, but not necessarily identical can be identified. Generally, a score is generated indicating the likelihood that the items (e.g., the search term and a node key) are in fact a match. The terms “fuzzy search” and “fuzzy match” are used herein interchangeably. Exact matching can be overly brittle, causing relevant data to be overlooked. Minor input errors or variations can prevent the search term from exactly matching a key of a node of the tree.

It can be more useful to users to provide a list of possible matches than to return a single exact match or no matches at all. Consequently, instead of determining whether the search term exactly matches the key of a node, the key can be evaluated to determine the probability that the key is a possible match for a search term. A threshold can be set to determine whether a node is similar enough to the search term to continue processing. If the score for the key is greater than predetermined threshold, the key can be added to a list of search results and/or child nodes of the current node can be evaluated. Alternatively, if the score is below the predetermined threshold, the key need not be added to the results list and further processing of child nodes of the current node may be unnecessary.

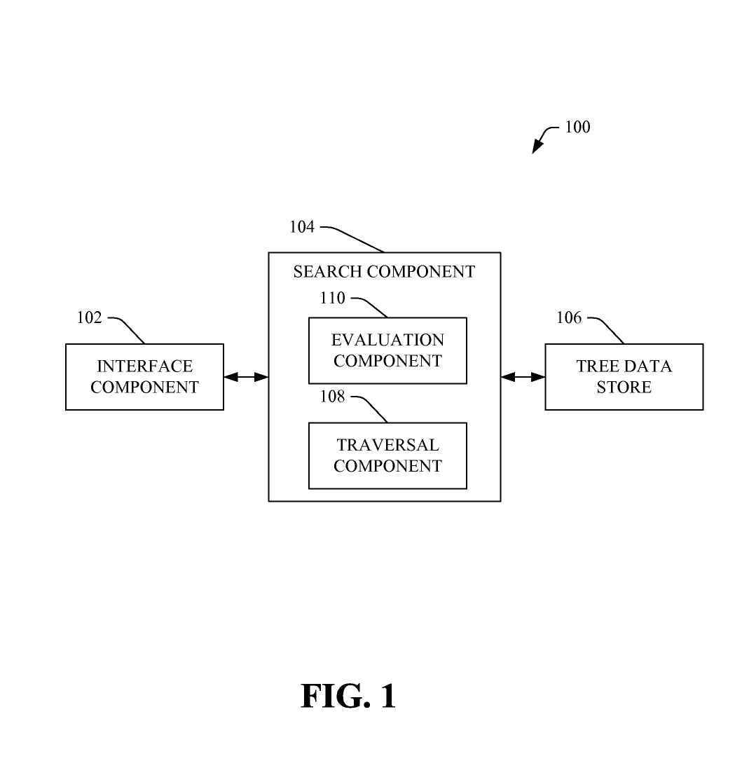

Referring now to FIG. 1, a system 100 for performing a fuzzy search of a tree data store is illustrated. The system 100 can include an interface component 102 that generates a search request including one or more search terms and a search component 104 that searches a tree data store 106 using the search term or terms. The interface component 102 can include a user interface, such as a graphical user interface (GUI) that allows users to enter search terms. The interface component 102 can also provide users with the ability to select a particular tree data store 106 to search. Alternatively, the interface component 102 can include any client or application that generates a search request for the search component 104 and receives search results.

The interface component 102 can generate one or more search requests for the search component 104 including any number of search terms. The search terms can be in any format. For example, the interface component 102 can generate a search request including a text string as a search term. In addition, a search request from the interface component 102 can include one or more search conditions or parameters for the search component 104. Search parameters can include a limitation on the number of search results produced, a limitation on the quality or type of search results, a time constraint, or a strategy to be used in searching or a function that determines the quality of match between the search term(s) and the possible results. The interface component 102 can include any means for entering search terms and conditions including, but not limited to, a keyboard, a microphone, or a tablet and stylus.

The search component 104 can utilize the specified search term(s) to search the tree data structure 106 in accordance with any search condition(s). The search component 102 can include a traversal component 108 that controls traversal of the tree data structure 106. During traversal each node can be evaluated by an evaluation component 110 to assess the difference between the key and the search term and determine if the key of the node is a possible match for the search term. A score reflecting the certainty of a possible match can be assessed to determine whether the current node is a possible match and whether any child nodes of the current node should be evaluated. The determination not to process child nodes of the current node eliminates branches of the tree 106 from evaluation, dramatically affecting processing speed and possibly impacting the search results provided. Consequently, it is critical that the determination as whether to process child nodes of the current node is intelligently made. Eliminating branches too easily reduces processing time, but can result in relevant data being missed. In contrast, if an insufficient number branches are eliminated, processing speed can be greatly reduced depending upon the size of the tree 106.

The evaluation component 110 can include an evaluation function or set of rules to generate a score indicative of the difference between the search term and the key of the node. The score should reflect the certainty of a match between the search term and the key. The evaluation component 110 can utilize any function or set of rules to determine if there is a possible match. In one embodiment, the evaluation function can be updated, allowing different evaluation functions to be compared and tested. In addition, the evaluation component 110 can include multiple evaluation functions, where different evaluation functions can be selected based on user preferences. The evaluation function can be specified or selected via the interface component 102. Alternatively, the evaluation function can be automatically selected based upon locale or purpose.

The evaluation function can be specified to provide for fuzzy matching of key nodes and search terms. For example, an evaluation function can be specified to generate a score for two text strings. The evaluation function can be used to match a search term string to key strings for the tree data structure 106. The strings can be evaluated on a character-by-character basis to determine the score based upon the search term string and a candidate key string. The score can be initialized to a perfect score and decremented or decreased by penalties for each incorrect or mismatched character. Penalties can be selected to reflect the relative importance of different types of mismatches between the search string and a candidate key string. For example, if the characters match exactly, no penalty is incurred. If characters match phonetically a small penalty can be incurred. If characters do not match at all, a much larger penalty can be incurred. Occasionally, multiple characters can be evaluated together to determine an appropriate penalty. For example, transposition of two characters should generate a lesser penalty than two independent, incorrect characters. Common errors include phonetic mistakes (e.g., Graphton and Grafton), extended characters (e.g., San Jose and San Jose), character permutations or transpositions (e.g., Rdemond and Redmond), missing characters (e.g., Nw York and New York) and extra characters (e.g., Misssissippi and Mississippi). In addition, penalties can be adjusted based upon the position of the error within the string. Errors near the start of a string may be considered more important and be penalized more heavily than errors that occur further into the string. The evaluation function can therefore apply a modifier to errors that occur near the beginning of the string. In addition, the length of the string can affect applied penalties. Raw penalties can also be adjusted to account for the length of the search string. For example, a mistake in a very long string tends to be less important than a mistake in a short string. The evaluation function can therefore apply a modifier to penalties based upon the length of the string.

The system 100 can also include a tree data store 106. The tree data store 106 can maintain a data set in a hierarchical organization intended to facilitate data retrieval. The terms “tree data store” and “tree” can be used interchangeably herein. Each node of the tree data store 106 can include a value or data. The value can serve as a reference to data associated with the node. The tree data store 106 can be implemented as a trie. A trie is an ordered tree, where the position of each node in the tree indicates the data or key associated with that node. For example, for a trie maintaining a group of text strings, the string or key for a node consists of the concatenation of all strings from the root node of the trie down to the node in question. The trie utilizes repetition in a data set to reduce search time and space consumption.

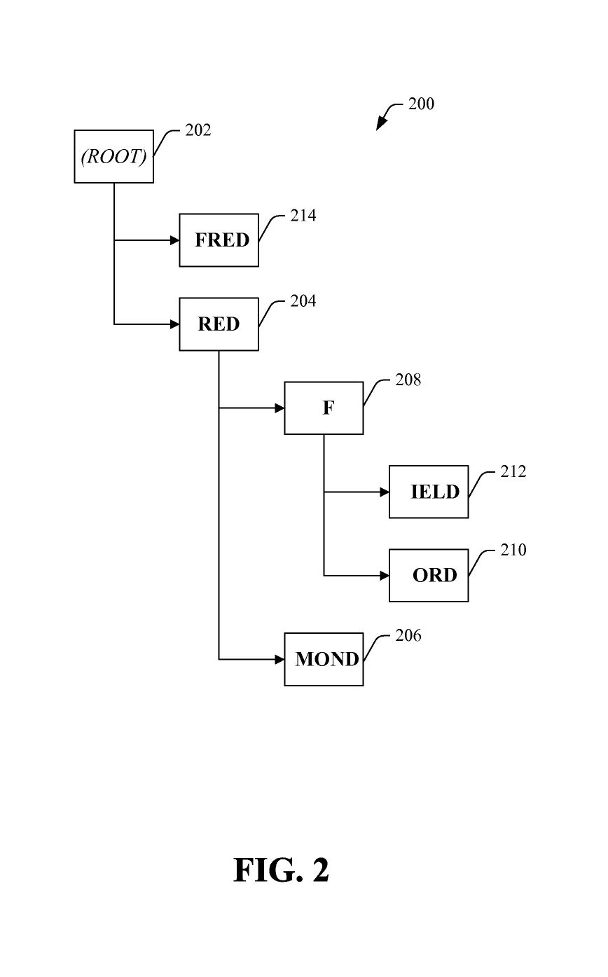

Referring now to FIG. 2, an exemplary trie 200 is illustrated. The trie is made up of a series of nodes, where each node except the root node 202 has a key. Here, the exemplary trie represents a set of text strings. If the data set includes multiple words beginning with the same letters, those letters can be collapsed in a single node, while the remainder of each word can be represented as a child node. Looking at the trie illustrated in FIG. 2, the words “Redmond” and “Redfield” both share the first three letters, “Red.” Therefore, a node can be created for the string “Red” 204 and two child nodes can be created for “mond” 206 and “field” (not shown). If the data set also includes the word “Redford,” an additional layer can be added including a node with a key “f” 208 shared by “Redford” and “Redfield.” Therefore, the string “Redford” can be represented by a node with key “ord” 210, which is a child of the node with key “f” 208, which is a child of the node with the key “Red” 204, which in turn is a child of the root node 202. The keys of nodes “Red” 204, “f” 208 and “ord” 210 can be concatenated to represent the string “Redford.” Similarly the keys of nodes “Red” 204, “f” 208 and “ield” 212 can be concatenated to represent the string “Redfield.”

For fuzzy matching using a trie, the score for any one node is dependent upon the parent node and ancestors of the node. In one embodiment, during traversal of the trie the current score can be set to a perfect score for the root node 202. As the trie is traversed, the score can be reduced by a series of penalties based upon mismatches between the search term and the keys of the nodes. If the score falls below a predetermined threshold, a determination can be made that the current node is not a possible match. In addition, because the score can only be further reduced for any child nodes of the current node, any such child nodes need not be evaluated. Accordingly, the search process need not navigate to the child nodes, reducing the amount of processing required to search the trie.

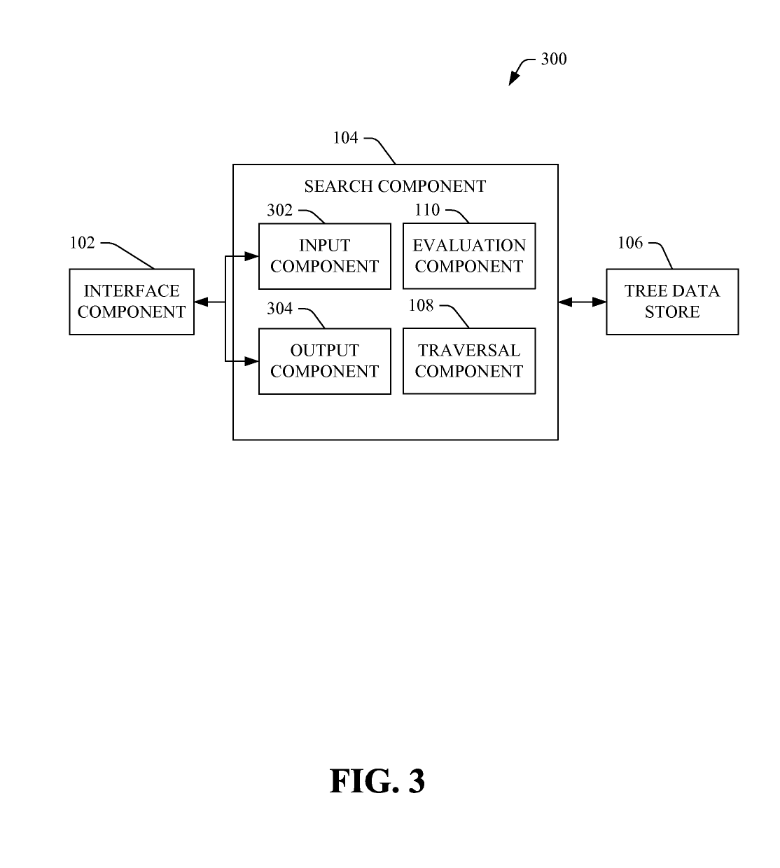

Referring now to FIG. 3, a system 300 for performing fuzzy matching using a trie data structure is illustrated. The search component 104 of system 300 can include an input component 302 that receives search requests from the interface component 102. The input component 302 can receive one or more search terms, one or more search conditions, an evaluation function or an indicator selecting an evaluation function. The input component 302 can format the search terms to facilitate retrieval of data from the tree data store 106. The input component 302 can apply any search conditions and update the evaluation function used by the evaluation component 110, if necessary. The input component 302 can also extrapolate search terms from the input. In particular, if the interface component 102 provides a limited means for inputting information (e.g. a phone keypad) the input component 302 can extrapolate possible search terms and/or conditions. For example, each key on a telephone can represent a number or one of several letters. In general “2” can represent “A”, “B” or “C” on most telephones. Accordingly, input component 302 can generate a series of search terms utilizing possible interpretations of the input from the interface component 102. Alternatively, the evaluation component 110 can be provided with a comparison function that recognizes such multi-representational inputs.

In addition, the input component 302 can receive search conditions from the interface component 102. For example, the input component 302 can use received search conditions to specify a threshold or thresholds for search results. The traversal component 108 can terminate traversal of a branch of the tree data store 106 if the score for the current node fails to meet the threshold. The input component 302 can also receive a request to utilize a specific, available evaluation function during node evaluation by the evaluation component 110. Alternatively, the input component 302 can receive a specific evaluation function from the interface component 102.

The interface component 102 can specify termination conditions for the search, such as a time constraint, a maximum number of search results or any combination thereof. For example, the interface component 102 can specify that the first ten search results found be returned, causing the traversal component 108 to halt traversal of the tree data store 106 upon location of ten results. Alternatively, the interface component 102 can specify a time constraint based upon the retrieval of a minimum number of search results, such that traversal halts upon expiration of the specified time period only if a minimum number of search results have been found.

The search component 104 can also include an output component 304 that prepares the search results for output to the interface component 102. Search results can include an indicator that no possible matches or results were found. The output component 304 can arrange the search results in order based upon the order in which the results were found, fuzzy score order, alphabetical order, numerical order or based upon any other suitable ordering of results. The output component 304 can also format the search results prior to providing the results to the interface component 102. In addition, the output component 304 can limit the number of search results to be returned to the interface component 102.

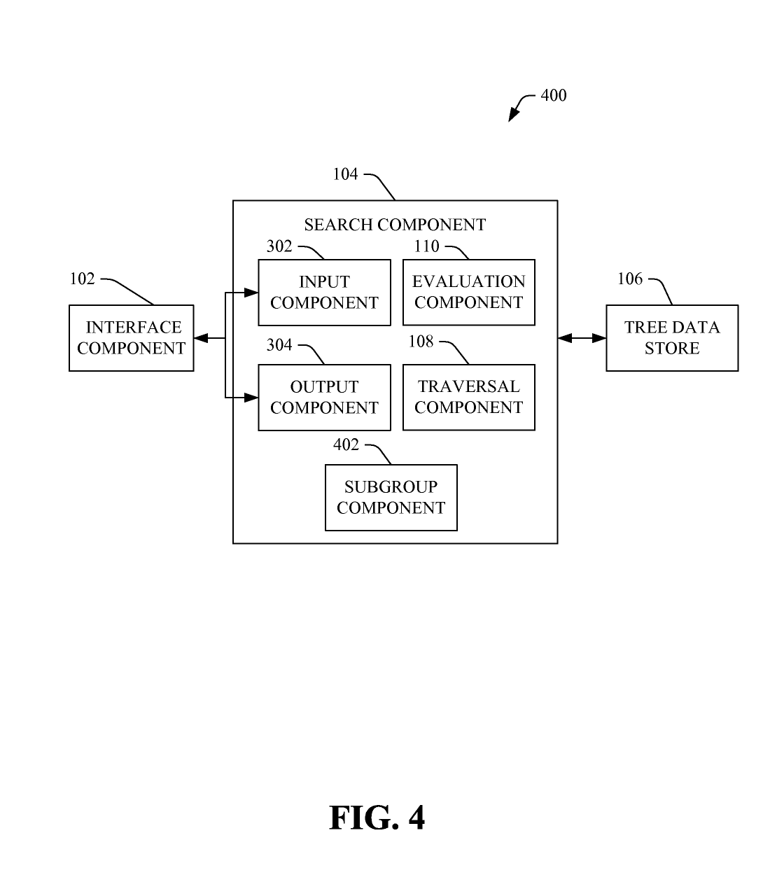

Referring now to FIG. 4, a system 400 for performing fuzzy matching utilizing subgroups is illustrated. So far, matching the search term to node keys has been described on an element-by-element basis. For example, in the string matching example described above, strings are compared on a character-by-character basis. However, the system 400 can provide for comparison and identification of mismatches on a subgroup-by-subgroup basis, where a subgroup can include multiple elements. Subgroup errors can be provided for by separating the search term into individual subgroups and processing each subgroup separately. After each subgroup is processed the results for all the subgroups can be evaluated by the subgroup component 402 to determine search results to be output.

Within the context of strings, a word is an example of a subgroup of a string. A single error at the subgroup level can cause multiple matching errors at the element level. For example, if the order of two words is reversed, a larger number of characters are likely to be mismatched. A search term can include extra words, lack certain words or include the appropriate words in an incorrect order. Inexactness at the subgroup level can cause dramatic inexactness at the element level, making it unlikely that the desired result will be found. For example, an entity name of “Martin Luther King” is unlikely to be retrieved based upon a search string of “Luther King” if the strings are compared on a character basis. An element-by-element comparison would compare the characters within the word “Martin” to the characters within the word “Luther.” However, if the string is evaluated on a subgroup or word basis it can be seen that two of the three relevant subgroups are included within the search string and both such subgroups are matched exactly. To prevent possible matches from being over-penalized for the single mistake, strings can be separated into words both when the tree data store 106 is built and when the search terms are provided.

To provide for searching for subgroups, entities including multiple subgroups can be stored or represented as individual subgroups in the tree data store 106. For example, strings of multiple word names can be stored as individual words in the tree data store 106 rather than as a single multi-word string. The phrase “Redfield Fred” can be stored individually as node “Fred” 214 and nodes “Red” 204, “f” 208 and “ield” 212 in the trie illustrated in FIG. 2. Each node whose key can be considered a subgroup of a larger entity can include an indicator that serves as a reference to the entity represented by the multiple subgroup data. The data can include both the number and order of subgroups in the complete entity.

Providing for subgroup searching using a trie data structure increases the likelihood that relevant data will be retrieved. For example, if the phrase “Redfield Fred” were stored as a single text string within the tree data store 106 and the interface component 102 mistakenly requested a search for “Fred Redfield”, it is unlikely that the node representing “Redfield Fred” would be located. However, by storing the words or subgroups separately, both “Redfield” and “Fred” can be located. The nodes representing “Fred” and “Redfield” can both include a reference to data associated with “Redfield Fred.”

After a search has been performed for each subgroup within the search term, the subgroup component 402 can evaluate the number of subgroups searched for, the number of subgroups found, and the number of words in the data referenced by the found nodes. For each set of subgroups identified, the number of subgroups missing from the search string relative to the found item, any extra subgroups, and the order of the subgroups can be evaluated. For each difference between the search subgroups and the found subgroups, a penalty can be applied to the score. Possible results can be returned by the output component 304 based upon the score.

Referring once more to the example with respect to FIG. 2, the phrase “Redfield Fred” would be retrieved because both words were present in the search term and matched in the correct order. In addition, the node “Fred” may be considered a possible match, since the search term included only one extra word. Both results, “Redfield Fred” and “Fred” can be returned if the results meet a minimum threshold. The interface component 102 or a user can decide which results are relevant from the output. Depending upon the threshold and possible penalties for inexact matching the search terms “Fred” or “Fred Redfield” could have located “Fred Redfield” as well. Although, the examples provided deal with strings and words, the subgroup component 402 can be used with any data type that can be subdivided into independently storable chunks or subgroups.

The subgroup component 402 can also remove subgroups that are too common to be useful during searching from search terms or trees. For example, words such as “the” and “of” appear in many names and can return too many results. Such words or subgroups can be stripped out of the search terms by subgroup component 402 prior to searching of the tree data store 106.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components may be combined into a single component providing aggregate functionality or divided into several sub-components. The components may also interact with one or more other components not specifically described herein but known by those of skill in the art.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

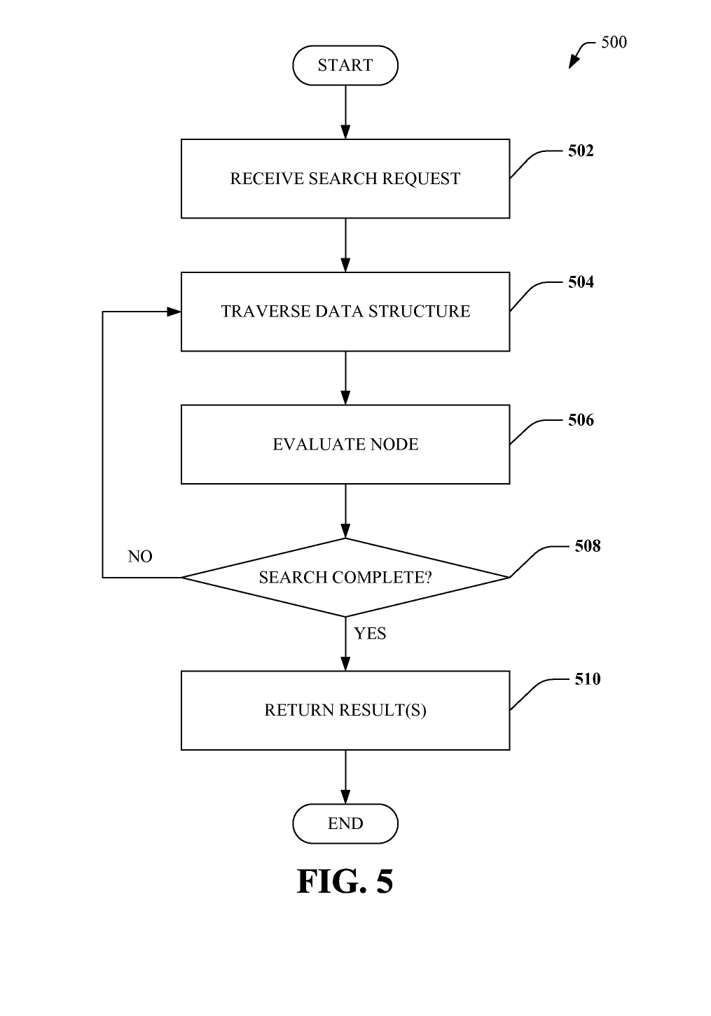

In view of the exemplary systems described supra, methodologies that may be implemented in accordance with the disclosed subject matter will be better appreciated with reference to the flowcharts of FIGS. 5-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

Referring now to FIG. 5, a methodology 500 for searching a tree data structure using fuzzy matching is illustrated. At 502, a search request is received. The search request can include one or more search terms as well as one or more search conditions. The search conditions can include one or more thresholds for determining whether a node of the data structure represents a possible match for the search term and/or whether to continue traversal of the data structure. The search conditions can also include one or more termination conditions such that when any of the termination conditions are met the search process ends. For example, termination conditions can include a time constraint that specifies a maximum amount of time that should be spent traversing the tree before returning any possible matches. In addition, termination conditions can include a maximum number of search results or possible matches. Once the maximum number of possible matches are located, the process returns the located, possible matches rather than continuing to traverse the tree.

In addition, the search conditions can include an evaluation function used during the search process. The evaluation function can be used to evaluate nodes or keys of nodes of the tree data structure to determine if the node constitutes a possible match for the search term or terms. Alternatively, the search conditions can include an indicator selecting an evaluation function from a set of provided evaluation functions.

At 504, the tree data structure is traversed to a first node. A variety of traversal methods can be utilized, such as depth first search, breadth first search and the like. At the node, the key of the node can be evaluated to determine if the node is a possible match for the search term at 506. The evaluation function can be used to evaluate the node key. In addition, during evaluation it can be determined whether the branch of the tree data structure, including the child nodes of the current node, should be further evaluated.

At 508, a determination is made as to whether the search is complete. The determination can be made based upon certain termination conditions, such as time constraints or limits on the number of results desired, as discussed above. The search can also be deemed complete if the entire tree data structure has been searched. If the search is not complete, the process returns to 504 where the tree data structure is traversed to the next node. If the search is complete, the process continues to 510, where the results of the search are returned. All of the results or a subset of the results can be returned. If no result matching the input was located, an indication that no results were located can be returned. In addition, the search results can be formatted, sorted, ordered and/or filtered.

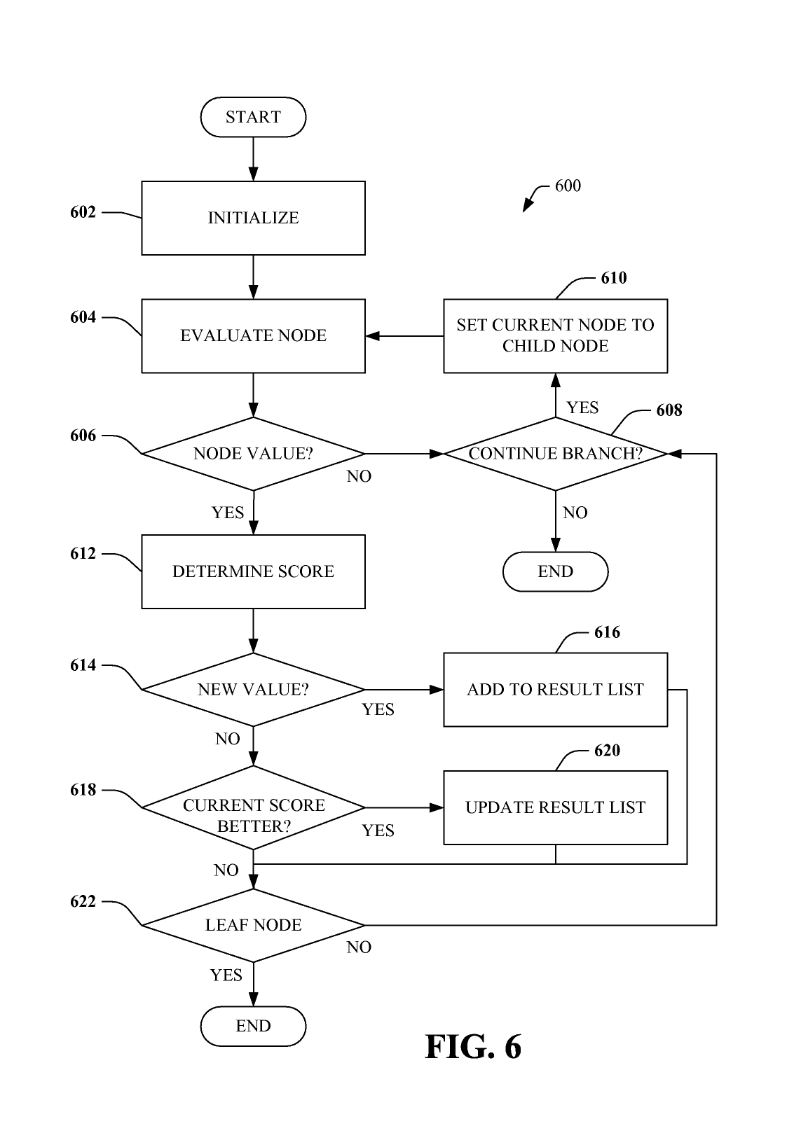

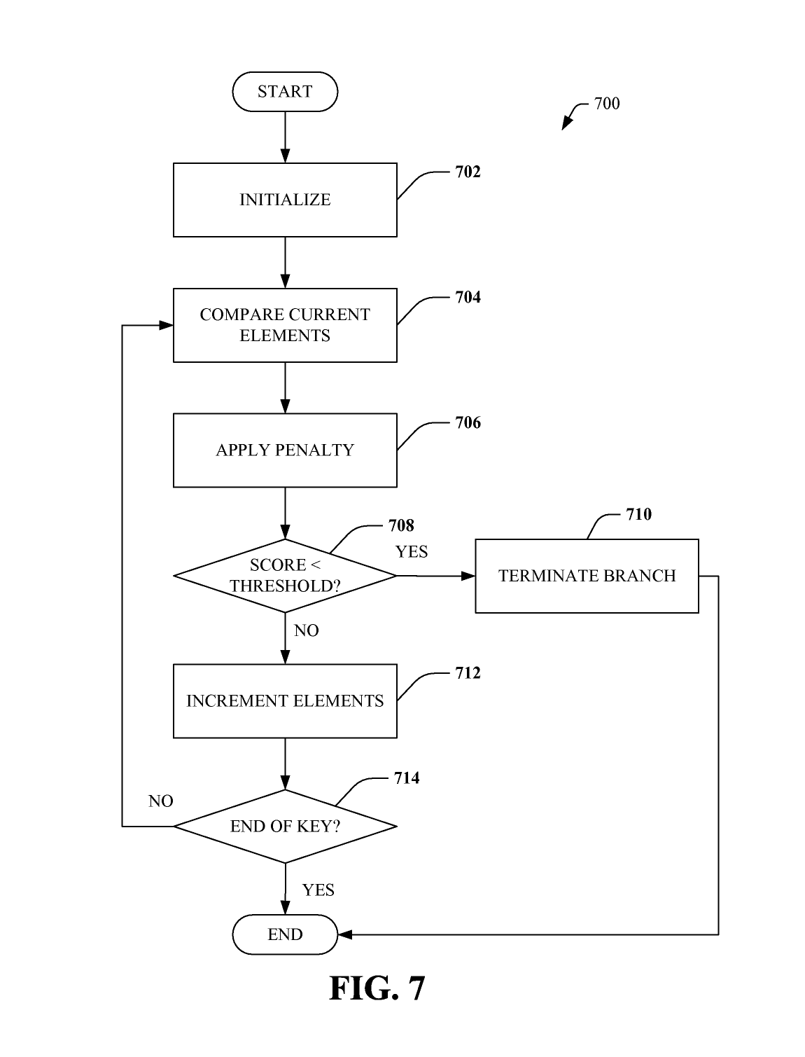

Referring now to FIG. 6, a methodology 600 for searching a tree data structure utilizing fuzzy matching is illustrated. At 602, the search is initialized. During initialization the root node of the tree can be selected as the current node, the current score can be set to the perfect score, and the current search element or character can be set to the first element in the search term. At 604, the current node is evaluated. During evaluation the score can be updated to reflect any error or difference between the search term and the key of the current node. Evaluation of the node can also determine whether child nodes of the current node should be evaluated. Node evaluation is discussed in detail below with respect to FIG. 7. At 606, a determination is made as to whether the current node includes a node value. A node value indicates that the node includes data that could be considered for a match to the search term. If no, the current node cannot be considered for inclusion in the results, but the node can have one or more child nodes. At 608, a determination is made as to whether to evaluate child nodes of the current node. If, no the process terminates for this branch of the tree. However if the child nodes are to be evaluated, the current node is set to a child node at 610 and the process continues at 604, where each child node is evaluated in turn. The process will continue recursively until each node is evaluated or a determination is made to terminate evaluation of a branch of the tree.

If it is determined at 606 that the current node has a value associated with it, any additional penalties can be applied and the final score for the current node is determined at 612. For example, the score can be further decreased if the search term includes extra elements not included in the current node. At 614, a determination is made as to whether the key or value for the current node has been previously located during traversal of the tree. It is possible that multiple branches of the tree lead to a node, or that nodes in the same branch could be evaluated in multiple ways at 612, therefore the key or value may have been previously investigated. If no, the key, value and associated score can be added to the result list at 616 and the process continues at 622, discussed below. If the key is not new and has already been added to the result list, a determination is made as to whether the current score is better than the score associated with the key in the result list at 618. If the score is better, the result list is updated with the current score at 620 and the process continues at 622, discussed below. If the score is not better than the current score in the result list, at 622 a determination is made as to whether the node is a leaf node and consequently has no child nodes. If yes, the traversal of the current branch terminates. The recursive process can continue to investigate or evaluate other branches of the tree. If the node is not a leaf node, the process continues to 608 where a determination is made as to whether to continue to process the current branch.

Referring now to FIG. 7, a methodology 700 for evaluating a node of a trie data structure is illustrated. At 702, the process is initialized. During initialization the candidate element can be set to the first element of the key of the node to be evaluated. For example, if the key is a string the candidate element can be set to the first character of the key string. The current candidate element can be compared to the current search element at 704. Any penalty for a non-perfect match can be applied to the current score at 706. The current score is also dependent on ancestors of the current node. If the keys of all ancestor nodes matched perfectly to the previous search elements, the score can be a perfect score. Otherwise, each imperfection for each previous node decreases the score. At 708, a determination is made as to whether the score is less than a predetermined threshold. If yes, the key of the node is too dissimilar to the search term, the branch is terminated at 710 and no further child nodes of the current node will be evaluated. If the score is greater than or equal to the threshold, the current candidate character and the current search character are incremented at 712. At 714, a determination is made as to whether the end of the key has been reached. If yes, the node evaluation process terminates. If no, the process returns to 704, where the current candidate character is compared to the current search character.

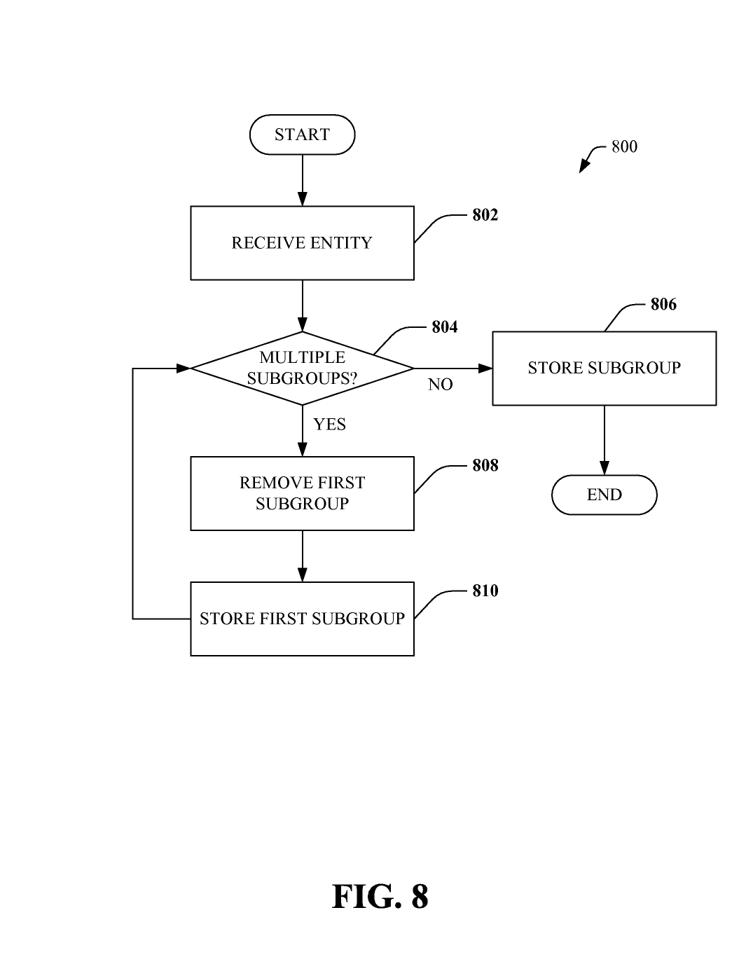

Referring now to FIG. 8, a methodology 800 for building a tree data store utilizing subgroups is illustrated. At 802, an entity to be stored in the tree data store is received. At 804, a determination is made as to whether the entity includes a plurality of subgroups. For example, if the entity is a text string, words included within the string can be considered subgroups. If the entity is made up of a single subgroup, the entity or subgroup can be stored in the tree data structure at 806 and the process terminates. However, if the entity includes two or more subgroups, the first subgroup can be separated from the remainder of the entity at 808. At 810, the first subgroup can be stored in the data tree structure. An indicator that the subgroup is part of a larger entity can be included in the tree data store. The remainder of the entity can be recursively processed by returning to 804. The remainder can be evaluated at 804 to determine whether it in turn includes two or more subgroups. In this manner the entity can be subdivided into its component subgroups and stored in the tree data structure. When subgroups that are parts of multiple subgroup entities are stored, information regarding the entity of which the subgroup is a part can be stored as well.

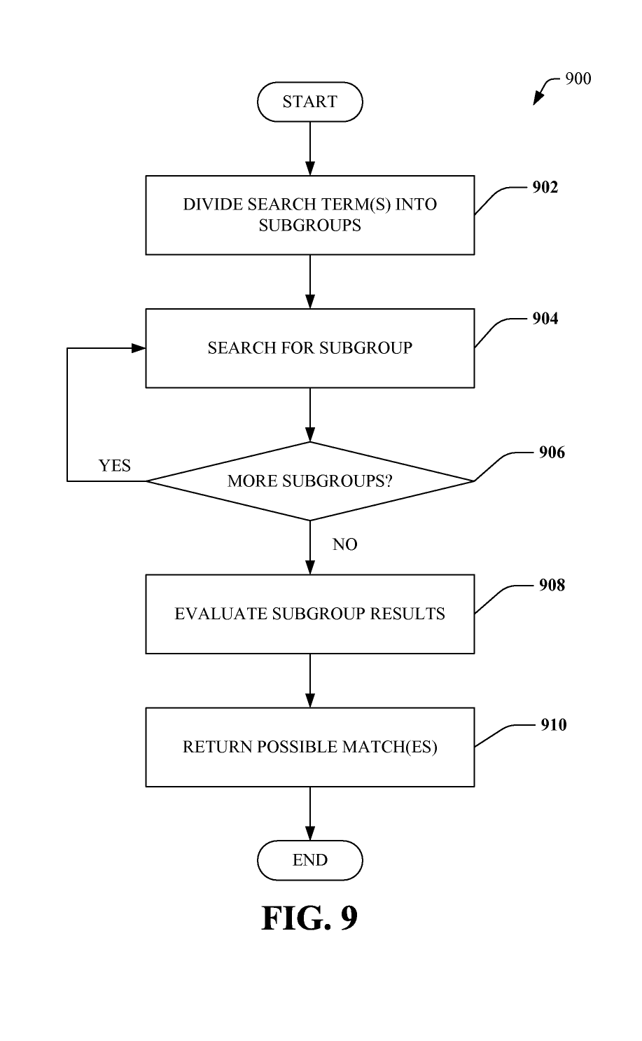

Referring now to FIG. 9, a methodology 900 for searching a tree data structure utilizing subgroups is illustrated. At 902, the search term or terms are divided into one or more subgroups. For example, an input string can be subdivided based upon individual words. Spaces within the input string can be detected and used to generate a set of word strings. At 904, the data tree structure can be searched for one of the subgroups of the search term. During the search, one or more possible matches can be identified and scores can be generated for the possible matches. At 906, a determination is made as to whether there are additional subgroups to process. If yes, the process returns to 904 where the data tree structure is searched for the next subgroup. If there are no additional subgroups, the subgroup results are evaluated as a whole at 908. For example, possible matches may not have been located for one or more of the subgroups. In addition, the order of the subgroups within the search term may vary from that of the possible match. Also, the possible match including multiple subgroups can include additional subgroups not found in the search term. Each of these possibilities can reduce the total score for the possible matches. At 910, the possible matches can be returned.

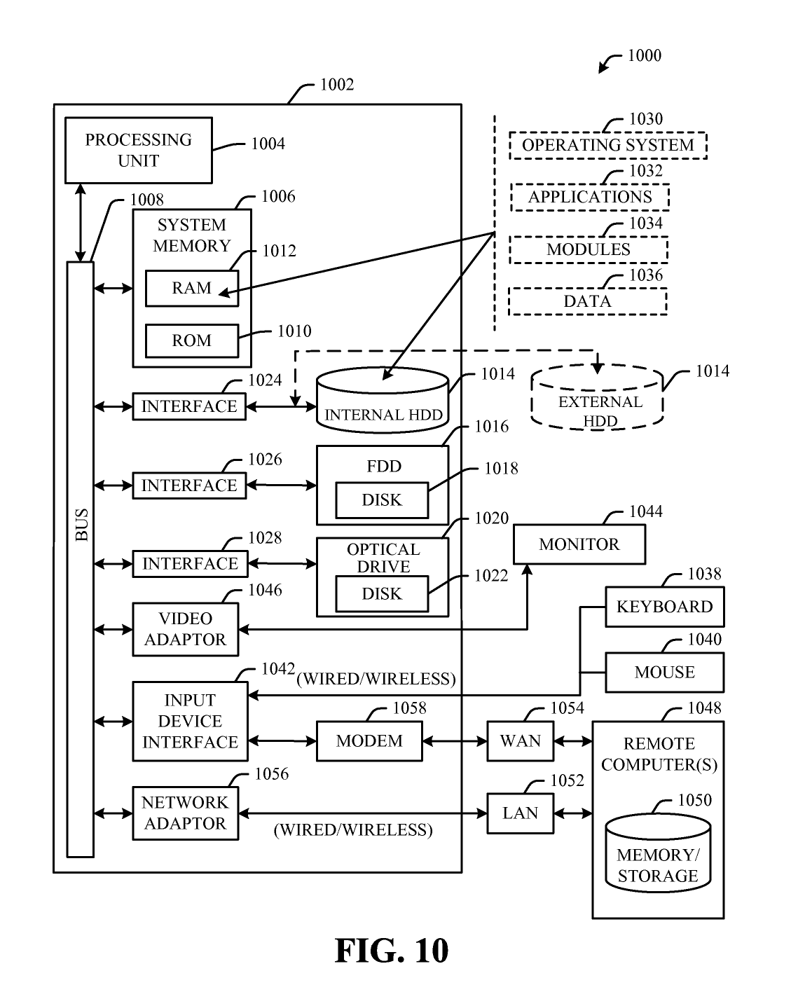

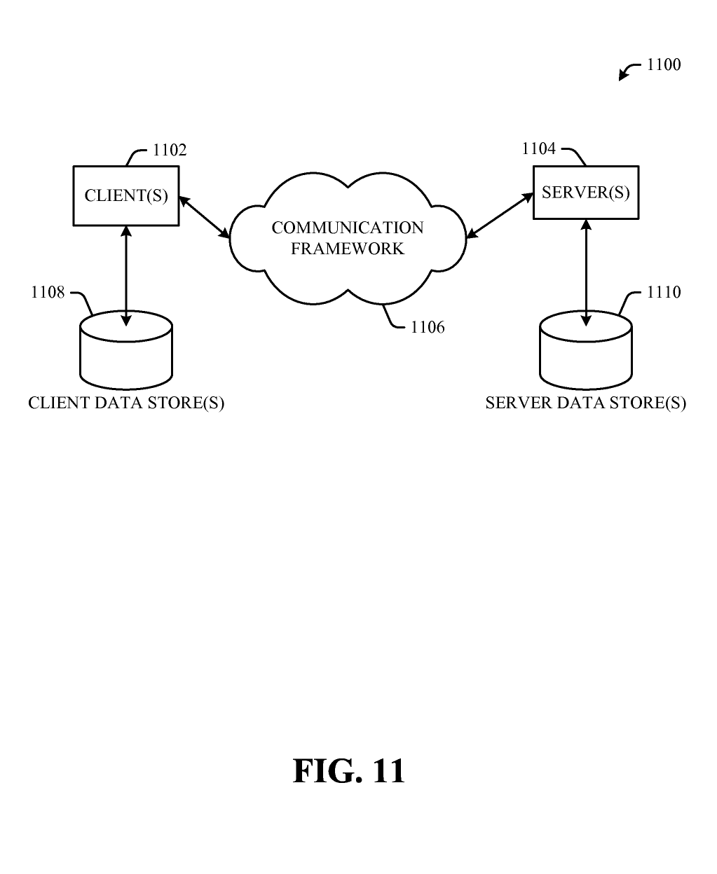

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovations described herein also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the subject matter described herein can be practiced on stand-alone computers. In a distributed computing environment, program modules may be located in both local and remote memory storage devices.

With reference again to FIG. 10, the exemplary environment 1000 for implementing various aspects of the embodiments includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject systems and methods.

The drives and their associated computer-readable media provide nonvolatile storage of data, data structures, computer-executable instructions, and so forth. Consequently, the tree data structures and search instructions can be stored using the drives and their associated computer-readable media. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods for the embodiments of the data management system described herein.

A number of program modules can be stored in the drives and RAM 1012, including an operating system 1030, one or more application programs 1032, other program modules 1034 and program data 1036. The application programs 1032 can include interfaces to the search system as well as the search system itself. All or portions of the operating system, applications, modules, and/or data can also be cached in the RAM 1012. It is appreciated that the systems and methods can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device can be used to provide the search results to a user. The display devices can be connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. For example, the interface and search instructions can be local to the computer 1002 and the tree data store can be located remotely on a remote computer 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, PDA, communications satellite, any piece of equipment or location associated with a wirelessly detectable tag (e.g., a kiosk, news stand, restroom), and telephone. Accordingly, an interface to the search system can be located on a wireless device in communication with a device or network that includes the search system and tree data structure. The wireless devices or entities include at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

FIG. 11 is a schematic block diagram of a sample-computing environment 1100 with which the systems and methods described herein can interact. The system 1100 includes one or more client(s) 1102. The client(s) 1102 can be hardware and/or software (e.g., threads, processes, computing devices). The system 1100 also includes one or more server(s) 1104. Thus, system 1100 can correspond to a two-tier client server model or a multi-tier model (e.g., client, middle tier server, data server), amongst other models. The server(s) 1104 can also be hardware and/or software (e.g., threads, processes, computing devices). One possible communication between a client 1102 and a server 1104 may be in the form of a data packet adapted to be transmitted between two or more computer processes. The system 1100 includes a communication framework 1106 that can be employed to facilitate communications between the client(s) 1102 and the server(s) 1104. The client(s) 1102 are operably connected to one or more client data store(s) 1108 that can be employed to store information local to the client(s) 1102. Similarly, the server(s) 1104 are operably connected to one or more server data store(s) 1110 that can be employed to store information local to the servers 1104.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A system for facilitating a fuzzy search of a tree data store, comprising:
a traversal component that traverses the tree data store to a node; and
an evaluation component that evaluates a key of the node to determine a score based at least in part upon a search term and the key, search results are based at least in part on the score.

2. The system of claim 1, the traversal component utilizes the score in determining traversal of the tree data store.

3. The system of claim 1, further comprising:
a subgroup component that evaluates subgroup results for a plurality of subgroups of the search term and generates a subgroup score based at least in part upon the search term and the subgroup results, the subgroup score is used in determining the search result.

4. The system of claim 1, further comprising:
an input component that receives the search term and at least one search condition.

5. The system of claim 4, the at least one search condition includes a termination condition.

6. The system of claim 4, the at least one search condition includes a traversal threshold, traversal of the tree data store is based at least in part on a comparison of the score to the traversal threshold.

7. The system of claim 1, further comprising:
an output component that outputs the search results, the search results are based upon the and an output threshold.

8. The system of claim 1, further comprising:
an interface component that allows a user to specify the search term and an evaluation function to be used by the evaluation component.

9. The system of claim 1, the tree data store is a trie.

10. A method facilitating fuzzy searching of a tree data store for a search term, comprising:
navigating the tree data store;
generating a score for a node of the tree data store utilizing a fuzzy matching function based at least in part upon the search term; and
determining search results based at least in part on the score.

11. The method of claim 10, further comprising:
updating the fuzzy matching function.

12. The method of claim 10, generating the score for the node further comprises:
applying a penalty determined by the fuzzy matching function to the score for each mismatch between the search term and a key of the node.

13. The method of claim 10, further comprising:
providing the search results to a user.

14. The method of claim 13, further comprising:
ordering the search results based at least in part upon the score.

15. The method of claim 13, providing the search results further comprises:
obtaining a value associated with the node
obtaining data from a data store using the value; and
providing the data to the user.

16. The method of claim 10, further comprising:
receiving a search request that includes the search term;
separating the search term into a plurality of subgroups; and
evaluating the subgroup results for each of the plurality of subgroups to determine a possible match for the search term.

17. A system for facilitating a fuzzy search of a tree data structure, comprising:
means for traversing the tree data structure;
means for evaluating a node to generate a score based at least in part on a search term utilizing a fuzzy matching function; and
means for providing search results based at least in part on the score.

18. The system of claim 17, further comprising:
means for separating the search term into a plurality of subgroups; and
means for evaluating subgroup results for each of the plurality of subgroups to determine the search results.

19. The system of claim 17, means for providing search results, further comprises:
means for obtaining a value associated with the node; and
means for obtaining data from a data store using the value associated with the node.

20. The system of claim 17, the tree data structure is a trie.
